(19) United States
(12) Patent Application Publication
(10) Pub. No.: US 2008/0055383 A1
(43) Pub. Date: Mar. 6, 2008

(54) Inkjet Recording Element

(76) Inventors: Olivier J. Poncelet, Chalon-Sur-Saone (FR); Christian S. Schmuckle, Chalon-Sur-Saone (FR)

Correspondence Address: EASTMAN KODAK COMPANY;PATENT LEGAL STAFF, 343 STATE STREET, ROCHESTER, NY, 14650-2201, US

(21) Appl. No.: 11/576,637

(22) PCT Filed: Sep. 28, 2005
(86) PCT No.: PCT/EP05/10451

§ 371 Date: Apr. 4, 2007

(30) Foreign Application Priority Data
Oct. 7, 2004 (FR) 04/10549

(51) Int. Cl. B41J 3/407

(52) U.S. Cl. 347/106

(57) ABSTRACT

The present invention relates to an inkjet recording element having good stability to ozone and to light. Said recording element comprises a support and at least one inkreceiving layer, said ink-receiving layer including particles of boehmite in filament form.

### FIELD OF THE INVENTION

The present invention relates to an inkjet recording element.

### BACKGROUND OF THE INVENTION

Digital photography has been growing fast for several years; the general public now having access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the inkjet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of the plates. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the base of inkjet printers used in office automation. With this method, the pressure in the ink cartridge is not maintained constant but is applied when a character has to be formed. In one widespread system there is a row of 12 open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps in the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of obtained image. The printing paper must combine the following properties: high quality printed image, rapid drying after printing, good dye keeping in time, smooth appearance, and high gloss.

In general, the printing paper comprises a support coated with one or more layers according to the properties required. It is possible, for example, to apply on a support a primary attachment layer, an absorbent layer, an ink dye fixing layer and a protective layer or surface layer to provide the glossiness of the recording element. The absorbent layer absorbs the liquid part of the water-based ink composition after creation of the image. Elimination of the liquid reduces the risk of ink migration to the surface. The ink dye fixing layer prevents any dye loss into the fibers of the paper base to obtain good color saturation while preventing excess ink that would encourage the increase in size of the printing dots and reduce the image quality. The absorbent layer and fixing layer can also constitute a single ink-receiving layer ensuring both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boehmite. Boehmite is the crystalline phase of aluminum oxyhydroxide (AlOOH). The boehmite particles used up to now as porous inorganic receivers have platelet-like form. They are obtained by hydrolysis in a basic medium of aluminum salts or alkoxides, the crystallinity level often being controlled by heat treatment. For example, European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal platelet-like boehmite) marketed by Sasol. However, printing paper comprising an ink-receiving layer containing such inorganic receivers can have poor image stability in time, which is demonstrated by a loss of color density.

To meet the new requirements of the market in terms of photographic quality, printing speed and color stability, it is necessary to offer a new inkjet recording element having the properties as defined above and more particularly good dye keeping properties in time, in particular shown by good stability of the printed image colors to ozone and light.

### SUMMARY OF THE INVENTION

The new inkjet recording element according to the present invention, comprises a support and at least one ink-receiving layer including boehmite particles, and is characterized in that said boehmite particles are in filament form.

The use of boehmite particles in filament form in an inkjet recording element enables a printed image to be obtained having improved stability, and in particular improved color stability of the printed image to ozone and light.

### BRIEF DESCRIPTION OF THE DRAWINGS

FIG. 1 represents the percentage of color density loss for various comparative recording elements and according to the present invention when exposed to ozone, and

FIG. 2 represents the percentage of color density loss for various comparative recording elements and according to the present invention when exposed to light.

### DETAILED DESCRIPTION OF THE INVENTION

The inkjet recording element according to the present invention comprises firstly a support. This support is selected according to the desired use. It can be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and their mixtures. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute an inkjet recording element. The side of the support that is used can be coated with a very thin layer of gelatin or another composition to ensure the adhesion of the first layer on the support. To improve the adhesion of the ink-receiving layer on the support, the support surface can also have been subjected to a preliminary treatment by Corona discharge before applying the ink-receiving layer.

The inkjet recording element according to the invention comprises at least one ink-receiving layer comprising at least one hydrosoluble binder. Said hydrosoluble binder can be a hydrophilic polymer such as poly(vinyl alcohol), poly(vinyl pyrrolidone), gelatin, cellulose ethers, poly(oxazolines), poly(vinylacetamides), poly(vinyl acetate/vinyl alcohol) partially hydrolyzed, poly(acrylic acid), poly(acrylamide), sulfonated or phosphated polyesters and polystyrenes, casein, zein, albumin, chitin, dextran, pectin, derivatives of collagen, agar-agar, guar, carragheenane, tragacanth, xanthan and others. In preference, gelatin or poly(vinyl alcohol) are used. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the poly(vinyl alcohol) from Nippon Gohsei, or Air Product under the name Airvol® 130.

According to the present invention, the ink-receiving layer includes boehmite particles in filament form, which are used as inorganic receivers. The filaments preferably have a form factor, i.e. a length/diameter factor, greater than 10, and still preferably greater than 20. Boehmites in filament form are obtained according to a known synthesis described in the publication, J. F. Hochepied, P. Nortier, Powder Technology 128 (2002) 268-275. The synthesis consists in adding soda and aluminum nitrate into osmosed water. The synthesis parameters defined in this publication are very important to control the boehmite's morphology and to obtain boehmite in filament form. The synthesis is carried out by double jet addition. The pH has to be near 9 and the temperature between 60° C. and 80° C. approximately. Additives can be added during the synthesis, such as glycol polyethylene used as surface-active to improve the dispersion of the filaments. The salts formed during the synthesis are then washed by settling. The resulting boehmite is characterized by transmission electron microscopy (TEM). A filament-like morphology is observed, i.e. filaments with an average length of about 100 nm and diameter between 3 nm and 5 nm approximately. Boehmite in filament form has a high specific surface, generally between 330 m²/g and 350 m²/g approximately.

After washing, the suspension formed is centrifuged and lyophilized. The resulting product is a powder.

The synthesis as described above can also be carried out by substituting part of the osmosed water by silica, like an aqueous suspension of silica Ondeo Nalco® 2329 marketed by the Ondeo Nalco Corporation. This synthesis enables the boehmite filaments to be grown in the presence of silica in order to obtain boehmite filaments dispersed and adsorbed at the surface of the silica particles.

The ink-receiving layer has between 5% and 95% by weight of filament-like boehmite particles compared with the total weight of the ink-receiving layer in the dry state. The boehmite filaments can be associated with other inorganic receivers, such as silicas, boehmites in lath form, aluminosilicates, etc.

The composition of the coating intended to form the ink-receiving layer is produced by mixing the hydrosoluble binder and the suspension of filament-like boehmite. The composition can also comprise a surfactant to improve its coating properties. The composition can be coated on the support according to any appropriate coating method, such as blade, knife or curtain coating. The composition is applied with a thickness between approximately 100 μm and 300 μm in the wet state. The composition forming the ink-receiving layer can be applied to both sides of the support. It is also possible to provide an antistatic or anti-winding layer on the back of the support coated with the ink-receiving layer.

The inkjet recording element according to the invention can comprise, besides the ink-receiving layer described above, other layers having another function, arranged above or below said ink-receiving layer. The ink-receiving layer as well as the other layers can comprise all the other additives known to those skilled in the art to improve the properties of the resulting image, such as UV ray absorbers, optical brightening agents, antioxidants, plasticizers, etc.

The inkjet recording element according to the invention has good dye keeping in time. It can be used for any type of inkjet printer as well as for all the inks developed for this technology.

The following examples illustrate the present invention without however limiting the scope.

1) Preparation of Boehmite Particles in Filament Form

Boehmites in filament form were prepared according to the synthesis method described in the publication, J. F. Hochepied, P. Nortier, Powder Technology 128 (2002) 268-275.

The synthesis was performed in a basin equipped with a stirrer capable of rotating up to 4000 rpm and a double jet injection system of reagents with pH and temperature regulation.

a) Synthesis 1

In a basin containing 4.8 l osmosed water at 60° C., 2.5 l of NaOH, 3M and 2 l of Al(NO₃)₃, 1M were added by double jet. The addition rates were 67 ml/min. The stirring varied between 2000 and 4000 rpm. The pH was set to 9 throughout the addition. At the end of addition (30 minutes), the temperature and pH conditions were maintained for two hours with the same stirring. Then the mixture was cooled to 25° C.

The resulting salts of the synthesis were washed by settling: at the end of synthesis, the suspension settled and after removal of the supernatant, the suspension was re-dispersed in osmosed water to reduce the salt concentration. This operation was repeated several times until the supernatant's conductivity was less than 50 μS.

Once the washing was finished, the suspension was centrifuged and lyophilized to obtain a material in powder form (boehmite 1).

Analysis by transmission electron microscopy (TEM) of the washed material showed that a material was obtained with filament-like morphology, with length between 60 nm and 200 nm, and preferably between 75 nm and 100 nm and diameter between 3 nm and 5 nm. An infrared spectrum produced with a Bruker IFS 66 apparatus enabled verification that the resulting material was a boehmite, compared with a reference boehmite (Disperal P2 commercial platelet-like boehmite, marketed by Sasol).

The specific surface was measured by the BET method (Brunauer, Emmet and Teller). The specific surface of filament-like boehmite 1 is 275.9 m²/g.

b) Synthesis 2

Synthesis 1 was reproduced, but with a temperature of 80° C. Boehmite 2 was obtained.

Analysis by transmission electron microscopy (TEM) of the washed material showed that a material was obtained with filament-like morphology, with length between 60 nm and 200 nm, and preferably between 75 nm and 100 nm and diameter between 3 nm and 5 mn. An infrared spectrum produced with a Bruker IFS 66 apparatus enabled verification that the resulting material was a boehmite, compared with a reference boehmite (Disperal P2 commercial platelet-like boehmite, marketed by Sasol).

c) Synthesis 3

Synthesis 1 was reproduced, but by adding to the osmosed water contained in the basin 3% by weight of polyethyleneglycol (mole weight=20,000) used as surface-active agent. Boehmite 3 was obtained.

Analysis by transmission electron microscopy (TEM) of the washed material showed that a material was obtained with filament-like morphology, with length between 40 nm and 100 nm, and preferably between 60 nm and 70 nm and diameter between 2 nm and 5 nm. An infrared spectrum produced with a Bruker IFS 66 apparatus enabled verification that the resulting material was a boehmite, compared with a reference boehmite (Disperal P2 commercial platelet-like boehmite, marketed by Sasol).

d) Comparison

Synthesis 1 was reproduced, but with a pH=5 and at a temperature of 25° C. An amorphous material was obtained (aluminum hydrate) which did not have filament-like form.

2) Preparation of Coating Compositions Constituting an Ink-Receiving Layer Coated on a Support

As hydrosoluble binder, poly(vinyl alcohol) was used (Gohsenol™ GH23 marketed by Nippon Gohsei) diluted to 9 percent by weight in osmosed water.

The compositions included as receiving agent particles of filament-like boehmite prepared according to syntheses 1 to 3 of paragraph 1 and the platelet-like boehmite Disperal P2, marketed by Sasol in powder form. All the coating compositions were obtained by mixing:
3 g receiving agent (dry matter)
4 g poly(vinyl alcohol) at 9%
15 g deionized water
   The powders were dispersed and crushed in water using a roller stirrer and five 10-mm diameter glass beads for 24 hours. Then the poly(vinyl alcohol) was added. The mixtures were homogenized using a roller stirrer and five 10-mm diameter glass beads for 15 minutes.
   3) Preparation of Inkjet Recording Elements

To do this, a Resin Coated Paper type support was placed on a coating machine, first coated with a very thin gelatin layer, and held on the coating machine by vacuum. This support was coated with a composition as prepared according to paragraph 2 using a blade means with a wet thickness of 200 μm. Then, it was left to dry for twelve hours at ambient air temperature (21° C.).

The resulting recording elements correspond to the examples shown in Table I below giving the receiving agent used in the ink-receiving layer:

TABLE I

| Recording | |
|---|---|
| element | Receiving agent in the ink-receiving layer |
| Ex 1 (inv.) | Filament-like boehmite 1 |
| Ex 2 (inv.) | Filament-like boehmite 2 |
| Ex 3 (inv.) | Filament-like boehmite 3 |
| Ex 4 (comp.) | Boehmite, Disperal P2 (platelet) |

4) Evaluation of Dye Keeping Properties in Time

To evaluate the dye keeping properties in time, a dye fading test by exposure to ozone is performed for each resulting recording element. To do this, targets, comprising four colors (black, yellow, cyan and magenta) were printed on each element using a KODAK PPM 200 printer and related ink. The targets were analyzed using a GretagMacbeth Spectrolino spectrophotometer that measured the intensity of the various colors. Then the recording elements were placed to the dark in a room with controlled ozone atmosphere (60 ppb) for three weeks. Each week, any degradation of the color density was monitored using the densitometer.

Also, for the resulting recording elements, a dye fading test is carried out by exposure to light of 50 Klux for two weeks. To do this, targets, comprising four colors (black, yellow, cyan and magenta) were printed on the resulting elements using a KODAK PPM 200 printer and the related ink. Then the printed targets were placed under a sheet of Plexiglas® 6 mm thick and totally transparent to the emission spectra of the neon tubes used (Osram Lumilux® FQ 80 W/840 Cool White), in order to minimize atmospheric oxidation phenomena. Any deterioration of the color density was measured using the densitometer after two weeks.

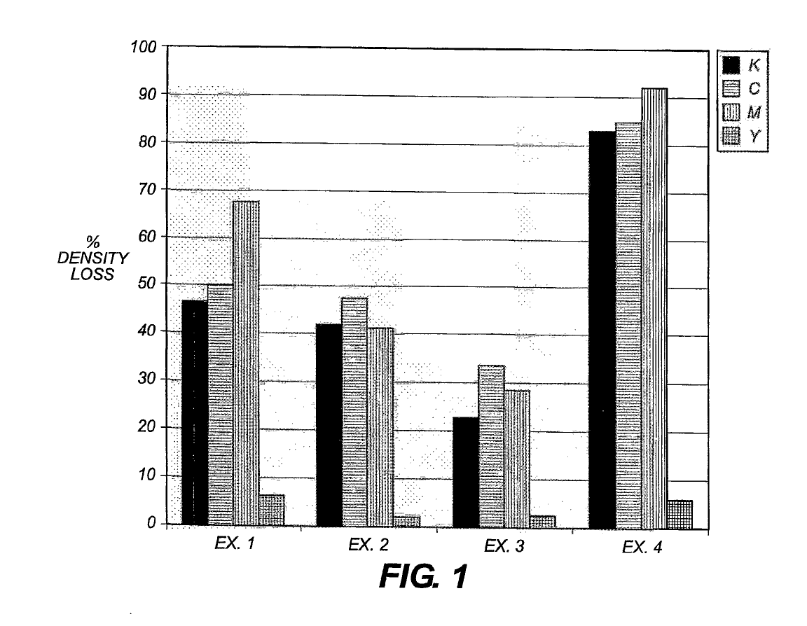

FIG. 1 represents the percentage of density loss observed for the maximum density for the four colors of the target after three weeks for examples 1 to 4 printed using the Kodak PPM 200 printer and exposed to ozone. Letters K, C, M and Y represent the colors black, cyan, magenta and yellow respectively.

It may be noted that the inkjet recording elements according to the invention (Examples 1 to 3) including particles of filament-like boehmite have a greater stability to ozone and thus better dye keeping than the comparative element including non-filament-like boehmite.

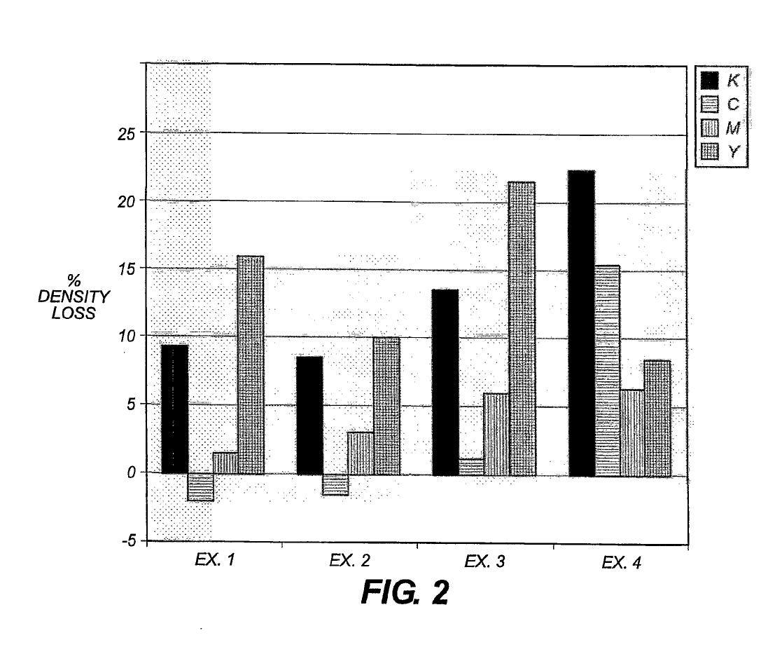

FIG. 2 represents the percentage of density loss observed for the maximum density for the four colors of the target after two weeks for examples 1 to 4 printed using the Kodak PPM 200 printer and exposed to light.

It may be noted that the inkjet recording elements according to the invention (Examples 1 to 3) including particles of filament-like boehmite have a greater stability to light and thus better dye keeping than the comparative element.

1) An inkjet recording element, comprising a support and at least one ink-receiving layer including boehmite particles, wherein said boehmite particles are in filament form.

2) The recording element according to claim 1, wherein the ink-receiving layer includes between 5% and 95% by weight of boehmite particles in filament form compared with the total weight of the dry receiving layer.

3) The recording element according to claim 1, wherein the ink-receiving layer comprises a hydrosoluble binder.

4) The recording element according to claim 3, wherein the hydrosoluble binder is gelatin or poly(vinyl alcohol).

5) Use of boehmite particles in filament form in an inkjet recording element, comprising a support and at least one ink-receiving layer for improving the stability of the image printed on said element.
